(19) United States
(12) Patent Application Publication
(10) Pub. No.: US 2023/0295032 A1
(43) Pub. Date: Sep. 21, 2023

(54) GLASS ARTICLE AND METHOD FOR PRODUCING A GLASS ARTICLE

(71) Applicants: TECHNISCHE UNIVERSITÄT BERGAKADEMIE FREIBURG, Freiburg (DE); 2MH GLAS GMBH, Dietzenbach (DE)

(72) Inventors: Thomas VOLAND, Grossweitzchen (DE); Sabine HÖNIG, Dittmannsdorf (DE); Martin GROSS, Pockau-Lengefeld (DE); Michael HEIDAN, Dietzenbach (DE)

(21) Appl. No.: 18/024,345

(22) PCT Filed: Sep. 2, 2021
(86) PCT No.: PCT/EP2021/074279

§ 371 Date: Mar. 2, 2023

(30) Foreign Application Priority Data
Sep. 3, 2020 (LU) LU102041

(51) Int. Cl. C03B 27/02; C03B 27/012; C03B 27/03; C03C 3/078; C03C 3/085; C03C 3/089; A47G 19/02

(52) U.S. Cl. CPC C03B 27/022; C03B 27/012; C03B 27/024; C03B 27/035; C03B 27/03; C03C 3/078; C03C 3/085; C03C 3/089; A47G 19/02; A47G 2400/10

(57) ABSTRACT

The invention relates to a method for producing a glass article. The method includes the step of producing a glass body from a glass material and the further step of bringing the glass body, at a primary temperature which is at most 50 Kelvin below and at most 30 Kelvin above the Littleton softening point of the glass material, into contact with a liquid cooling agent which has a cooling agent temperature which is at least 200 Kelvin and at most 550 Kelvin below the primary temperature.

### CROSS-REFERENCE TO RELATED APPLICATIONS

The present application is a national phase entry under 35 USC § 371 of International Application PCT/EP2021/074279 filed Sep. 2, 2021, claiming priority to and benefit of Luxembourgian Patent Application No. 102041 filed Sep. 3, 2020, the entire disclosure of which is incorporated herein by reference.

### FIELD

The disclosure relates to a method for producing a glass article.

### BACKGROUND

There are a variety of hardening and strengthening methods known for ideally adapting glass, as a versatile high-tech material, to the particular use. The majority of hardening and strengthening methods either can be employed only at great cost and complexity, and/or have relied on the use of—usually expensive—specialty glass.

For example, it is known practice to increase the fracture strength of glass through what is called thermal prestressing (colloquially also called thermal hardening or heat treatment). In this case the glass workpiece to be strengthened is heated in a kiln to around 600° C. and then rapidly quenched to room temperature. This quenching causes the surface to solidify, and there is little subsequent change in the external dimensions of the component. Stresses are developed within the glass workpiece, and lead ultimately to a higher fracture strength.

DD 1579 66 discloses a method and an apparatus for the strengthening of glass products by ion exchange. The glass products in this case are strengthened by exchange of alkali metal ions between the glass surface and alkali metal salt melts. The strengthening sees hollow glass products with their opening turned downward, or hollow glass products which are rotated or swiveled about a horizontal axis, being irrigated with the salt melt. In this operation, the salt is continuously circulated and passed through perforated plates to generate a cascade of irrigation for the glass products, which are arranged in multiple layers. Unfortunately, for economic viability, this method can only be utilized with the use of comparatively expensive specialty glass.

DE 195 10 202 C2 discloses a method for producing hollow glass bodies by the blow-and-blow and press-and-blow shaping method with enhanced mechanical strength. A feature of the method is that the blow press air in the parison mold and/or finish mold of the blow-and-blow shaping method or in the finish mold of the press-and-blow shaping method is admixed with mists of aqueous alkali metal salt solutions.

DE 11 2014 003 344 T5 discloses a chemically hardened glass for flat screens of digital cameras, mobile phones, digital organizers, etc. The chemically hardened glass has a compressive stress layer generated by an ion exchange method, with the glass having a surface roughness of 0.20 nm or higher and with the hydrogen concentration Y in the region to a depth X from an outermost surface of the glass satisfying the equation Y=aX+b where X=from 0.1 to 0.4 (μm). The glass is preheated to a temperature of 100° C. and then immersed in molten salt.

### SUMMARY

It is the object of the present disclosure to specify a method for producing an inexpensive glass article which is particularly resistant and robust.

The object is achieved by a method which is characterized by steps as follows:
a. producing a glass body from a glass material,
b. contacting the glass body, at a primary temperature which lies at most 50 kelvins below and at most 30 kelvins above the Littleton softening point of the glass material, with a liquid cooling agent which exhibits a cooling agent temperature which lies at least 200 kelvins and at most 550 kelvins, more particularly at least 200 kelvins and at most 450 kelvins, below the primary temperature.

The disclosure in particular has the very special advantage that even comparatively inexpensive glass material, such as simple utility glass, for example, more particularly container glass, can be used as starting material, to ultimately obtain especially fracture-resistant glass articles. In particular it has emerged that the glass articles produced according to the method of the disclosure are more fracture-resistant than glass articles made from the same glass material that have been cooled conventionally.

The disclosure has the special advantage that particularly for utility articles in daily life, by virtue of the enhanced fracture strength, the required wall thickness of the glass article is lower. This has the consequence that in the production of the glass articles, relative to glass articles produced conventionally from the same glass material, glass can be saved. More particularly, therefore, the glass articles produced in accordance with the disclosure have a lower intrinsic weight than glass articles produced conventionally from the same glass material.

In a manner in accordance with the disclosure it has been recognized in particular that particularly good results are achieved if the glass body—in contrast to the conventional heat treatment—is not quenched suddenly to room temperature. It has further been recognized that the initial cooling rate is determined substantially by the difference between the primary temperature and the cooling agent temperature and also by the material-specific heat transfer coefficient. Particularly good results in terms of fracture strength are achieved more particularly if the primary temperature and the cooling agent temperature are selected in such a way that the initial cooling rate is in the range from 80 kelvins to 120 kelvins per second, more particularly in the range from 90 kelvins to 110 kelvins per second, or is 100° Kelvin per second. In one particular version, the initial cooling rate is not less than 80 kelvins per second, more particularly not less than 100 kelvins per second.

As set out later on below in detail, the glass material may advantageously be an alkali-containing silicate glass, more particularly an alkali metal-alkaline earth metal silicate glass, very particularly a soda-lime glass, or a borosilicate glass or an aluminosilicate glass. Alkali metal-alkaline earth metal silicate glass in particular has the particular advantage that it is inexpensively obtainable and yet can be processed by the method of the disclosure to form particularly fracture-resistant glass articles. Especially when using alkali metal-alkaline earth metal silicate glass as glass material, the primary temperature may lie advantageously in the range from 700° Celsius to 760° Celsius, more particularly in the range from 720° Celsius to 740° Celsius. Correspondingly, the cooling agent temperature, especially if the cooling agent comprises, for example, a molten salt, such as molten sodium salt or molten potassium salt, for example, may lie in the range from 350° Celsius to 500° Celsius, more particularly in the range from 390° Celsius to 450° Celsius or in the range from 420° Celsius to 440° Celsius, especially in order to achieve the advantageous cooling rate stated above.

Results with particularly good reproducibility can be achieved if the primary temperature lies at most 30° Celsius below and at most 10° Celsius above the Littleton softening point of the glass material, or if the primary temperature corresponds to the Littleton softening point.

The Littleton softening point is the temperature at which the viscosity is 10^{6.6} Pa s (pascal times second).

In one especially advantageous version of the method of the disclosure, the glass body is produced from a melt of the glass material, more particularly at a temperature of above 1500° Celsius, and is cooled in a first cooling process, without contact with the liquid cooling agent, more particularly outside a cooling bath, until the primary temperature is reached. As soon as the primary temperature has been reached, the glass body is contacted with the cooling agent, being immersed for example in a cooling bath which contains the cooling agent. A very particular advantage of this procedure is that energy can be saved, in that a part of the process heat which the glass body still has from its production is utilized for the hardening and/or strengthening process and there is therefore no need for separate heating of the glass body (initially chilled beforehand below the primary temperature) to the primary temperature (although such separate heating, as explained comprehensively later on below, is also entirely possible as an alternative). This procedure is particularly appropriate for a continuous production process, in which glass bodies are progressively produced and continuously contacted in succession (when the primary temperature has been reached in each case) with the cooling agent, by being immersed, for example, in a cooling bath which contains the cooling agent. The continuously produced glass bodies may more particularly travel through a cooling section up to the contacting, more particularly up to the cooling bath, with the cooling section, the ambient temperature and the travel speed being selected such that the glass bodies each arrive at the location of the contacting, more particularly at the cooling bath, at precisely the time when they have cooled to the primary temperature, which in the case of immersion corresponds to an immersion temperature. In particular, the glass bodies may be moved continuously in succession through the cooling bath and removed continuously in succession.

As an alternative it is also possible for the glass body, initially chilled (below the primary temperature and more particularly to room temperature), to be heated to the primary temperature prior to the contacting. This procedure is especially advantageous for a discontinuous production process, in which the glass bodies produced and cooled to room temperature conventionally are assembled into batches for further processing, in particular on a separate transport mount in each case.

The heating may advantageously be accomplished by transferring the glass body (in particular together with other glass bodies of a batch) into a kiln. The kiln may advantageously have a kiln temperature which corresponds to the Littleton softening point of the glass material or which lies at most 50 kelvins below and at most 30 kelvins above the Littleton softening point of the glass material. More particularly the kiln may advantageously have a kiln temperature which lies in a range from 10 kelvins to 40 kelvins above the primary temperature. When using alkali metal-alkaline earth metal silicate glass as glass material, in particular, the kiln temperature may lie advantageously in the range from 650° Celsius to 770° Celsius, more particularly in the range from 740° Celsius to 760° Celsius or in the range from 680° Celsius to 730° Celsius, or may be 750° Celsius.

It is important to ensure that the glass body remains in the kiln for a sufficient time to reach (at least at its outermost layer) the primary temperature. However, the glass body must not remain too long in the kiln, in order to avoid unwanted deformation of the glass body. It has emerged that in the case of glass bodies which are embodied as hollow bodies with walls having wall thickness, particularly good results are achieved if the glass body remains in the kiln for a heating time in the range from 35 seconds to 90 seconds, more particularly from 45 seconds to 70 seconds per millimeter of wall thickness, more particularly for a heating time of 55 seconds per millimeter of wall thickness. In the case of a glass body whose walls have different thicknesses at different points, the wall thickness at the thinnest point is preferably decisive for the heating time. In the case of glass bodies which have a flat embodiment and a thickness, particularly good results are achieved if the glass body remains in the kiln for a heating time in the range from 35 seconds to 90 seconds, more particularly from 45 seconds to 70 seconds, per millimeter of thickness, more particularly for a heating time of 55 seconds per millimeter of thickness. In the case of a glass body which has different thicknesses at different points, the thickness at the thinnest point is preferably decisive for the heating time.

Especially in the case of glass bodies which have a wall thickness or a thickness of more than 2 millimeters, more particularly of more than 3 millimeters, and/or of glass bodies which have very different wall thicknesses or thicknesses in different regions, the heating may take place, in an especially advantageous way, in a multistage, more particularly two-stage, process. In particular it may be advantageous for the glass body to be first heated slowly to a first temperature and then heated rapidly to the primary temperature. In particular it may be advantageous for the glass body to be heated first at a first heating rate to a first temperature and then heated to the primary temperature at a second heating rate which is above the first heating rate.

This procedure has the very particular advantage that unwanted deformation of the glass body is effectively avoided, since all of the regions of the glass body attain the primary temperature simultaneously or at least within a specified or specifiable time window. This prevents the situation where the regions of the glass body which can be heated more rapidly undergo (unwanted) deformation even while it is still necessary to wait until other regions, which can be heated up less rapidly, reach the primary temperature.

Furthermore, this procedure has the very particular advantage that it prevents or at least reduces interactions that occur at high temperatures between the glass body and the holder that holds and/or transports the glass body during the implementation of the method.

The first temperature lies advantageously in a range from 50 degrees Kelvin below to 100 kelvins above the transformation temperature of the glass material, more particularly in a range from 0 kelvins to 50 kelvins above the transformation temperature of the glass material. The transformation temperature is the temperature at which the glass, during cooling, transitions from the plastic range into the rigid state; more particularly, the temperature at which the viscosity is 10^{12.3} Pa s (pascal times second).

In order to achieve this, the kiln temperature may for example be increased after the first heating phase. An alternative possibility as well is to use two kilns having different kiln temperatures, with the glass body after the first heating phase being transferred for the second heating phase from the first kiln into the second kiln, which has a higher kiln temperature. In one especially advantageous version, a kiln is used which has kiln regions differing in temperature, allowing the glass body after the first heating phase in a first kiln region to be transferred to a second kiln region for the second heating phase.

In particular it is possible advantageously for the glass body to be heated first at a first kiln temperature and thereafter at a second kiln temperature which is higher than the first kiln temperature. In this case it is particularly advantageous if the glass body is exposed to the second kiln temperature for a heating time in the range from 60 seconds to 120 seconds, more particularly from 80 seconds to 100 seconds, or for a heating time of 90 seconds. In this way, the glass body reaches the primary temperature at all points, without any deformation of the glass body occurring.

In the case of alkali metal-alkaline earth metal silicate glass, the upper kiln temperature may lie advantageously in the range from 680° Celsius to 730° Celsius.

In an especially advantageous version, the contacting takes place by immersion of the glass article in a cooling bath which contains the cooling agent. It is also possible in an alternative, for example, for the contacting to take place by spraying or by sprinkling with the cooling agent.

In an especially advantageous version, the glass article is contacted exclusively with a single liquid cooling agent. Alternatively or additionally, it is possible advantageously for the cooling bath to contain only a single, homogeneously mixed liquid cooling agent and/or for there to be only a single layer with the single liquid cooling agent in the cooling bath.

In the case of a discontinuous production process, it may in particular be advantageous for multiple glass bodies of one batch, produced and cooled to room temperature in a conventional way, to be arranged each in a separate transport mount and then hardened and/or strengthened together and simultaneously in the manner described above. More particularly, each batch can be heated by transferring the transport mount which carries the glass bodies of the batch into the kiln. The transport mount together with the glass bodies may then be contacted with the cooling agent, in particular, for example, by being immersed in a cooling bath.

After a predetermined time has elapsed from the contacting, more particularly an immersion, of preferably longer than five minutes, more particularly longer than ten minutes, the glass body is withdrawn from the cooling bath and cooled further, and cleaned, in a cooling position outside the cooling bath.

The cooling agent may be, for example, an oil. It is also possible for the cooling agent to comprise a molten metal, such as tin, potassium or sodium, for example, or a metal mixture. More particularly it is possible to use a mixture of sodium and potassium. Sodium-potassium mixtures with a potassium content of 45% to 89% are liquid even at room temperature. For a concentration of 22% sodium and 78% potassium, the boiling point is 785° C. and hence in particular above the Littleton softening point of alkali metal-alkaline earth metal silicate glasses, more particularly of container glass.

As cooling agent it is advantageously possible in particular to use a salt melt. It has emerged that particularly scratchproof surfaces of the glass article are achieved if the cooling agent used comprises a potassium salt melt. The potassium salt melt may contain, in particular, potassium nitrate and/or potassium carbonate and/or potassium hydroxide and/or potassium hydrogen carbonate and/or potassium phosphate. It is also possible, for example, to use a salt melt which (alternatively or additionally to at least one potassium salt) contains a sodium salt. The salt melt may in particular contain sodium nitrate and/or sodium carbonate and/or sodium hydroxide and/or sodium hydrogen carbonate and/or sodium phosphate.

In an especially advantageous version, the liquid cooling agent is contacted progressively or at time intervals, more particularly constant time intervals, with a regeneration material, more particularly a solid regeneration material, which is configured to maintain physical and/or chemical properties of the cooling agent and/or to delay any alteration in physical and/or chemical properties of the cooling agent. In this way the usage duration of the cooling agent can be prolonged.

The regeneration material may in particular be configured to bind soiling substances which are carried into the liquid cooling agent as a result of contact with the hot glass bodies and/or as a result of contact with carrier devices which carry the glass bodies during the cooling procedure. In particular the regeneration material may be configured to take up chemical substances which emanate from the glass bodies and/or from a carrier device in the course of a cooling procedure, and/or to replace them with different chemical substances.

Alternatively or additionally, the regeneration material may be configured to release chemical substances into the cooling bath that can be taken up by the glass bodies and/or by a carrier device. In particular it may be advantageous for the regeneration material to release chemical substances into the liquid cooling agent that improve the physical and/or chemical properties of the glass articles to be produced and/or of a carrier device. For example, the regeneration material may be configured to release chemical substances which enhance the strength, particularly the scratch resistance, and/or the hardness of the glass article.

In one especially advantageous version, the regeneration material is a glass or contains a glass. This has the advantage in particular that the regeneration material in the form of solid bodies, as for example in the form of beads, granules, plates, corrugated plates, irregularly corrugated plates, plates with irregular surface or glass fibers or as nonwoven or glass frits or sintered material, can be easily contacted with the liquid cooling agent. Particularly in the case of glass articles produced from the glass material above, there is particular advantage in using a regeneration material which contains a potassium-containing silicate glass or consists of a potassium-containing silicate glass. The regeneration material may in particular have been melted from a raw material mixture which as well as potassium oxide additionally contains at least one further oxide, more particularly from the following group: aluminum oxide, boron oxide, sulfur oxide, calcium oxide. In particular it may be advantageous for the regeneration material to be melted from a raw material mixture which as well as potassium oxide additionally contains multiple oxides, more particularly from the following group: aluminum oxide, boron oxide, sulfur oxide, calcium oxide, in equal or different proportions. Through the use of such a regeneration material it is possible to prevent or at least very substantially delay at least one of the three key aging phenomena of the liquid cooling agent that are stated below, especially in a cooling bath. In particular it is possible to avoid or at least very substantially delay an increase in the concentration of extraneous alkali metal ions, such increase being disadvantageous for the physical properties of the glass articles. Alternatively or additionally, it is possible to prevent or at least very substantially retard the decomposition and hence an increase in pH of the liquid cooling agent. Furthermore, particulate impurities may be prevented or reduced in particular by the binding of particulate impurities as soon as they come into contact with the preferably solid regeneration material within the liquid cooling agent.

Alternatively or additionally, the regeneration material may be configured to release chemical substances which prevent or at least retard scaling of a carrier device which carries the at least one glass body during the cooling procedure. Scaling comes about through the reaction of the material of the hot carrier device—steel or stainless steel, for example—with the ambient air. Because of the continual temperature change involved in immersion and removal, the scale flakes off and contaminates the liquid cooling agent. This may be reduced or at least diminished by means of a regeneration material which releases chemical substances into the liquid cooling agent that react with the surface layer of the carrier device and/or attach to the surface of the carrier device and so prevent direct contact between the carrier device and the ambient air. For example, through the attachment of a potassium silicate layer, the carrier device may be rendered inert, to a certain extent, to the formation of scale.

In one especially advantageous version, the regeneration material remains in contact with the liquid cooling agent during the cooling procedure, more particularly during a multiplicity of successive cooling procedures. This may be realized, for example, by introducing the regeneration material into a cooling bath in which the liquid cooling agent is located and in which the glass body is immersed during the production of the glass article.

According to an independent inventive concept, the regeneration material may be present advantageously in particular in the form of beads, granules, frits, fibers, plates, corrugated plates, irregularly corrugated plates and/or plates having an irregular surface. In this way, advantageously, a high surface area is achieved by comparison with the volume, and hence a large contact area with the salt melt is achieved, allowing a high activity to be achieved for a given level of usage of regeneration material. Especially advantageous—according to an independent inventive concept—is regeneration material in the form of a multiplicity of irregularly corrugated plates or plates having an irregular surface, since such plates are unable to cling flatly to one another, which would deleteriously reduce the effective overall surface area of the regeneration material bodies. Very generally, therefore, advantageous provision may be made for the regeneration material bodies used to have a similar basic form, but with the individual regeneration material bodies differing to an extent such that flat clinging to one another (as in the case of flat plates, for example) is prevented. The individual regeneration material bodies may advantageously have a size, more particularly diameter, particle size and/or thickness, in the range from 0.1 mm to 10 mm.

As already mentioned, the glass material may advantageously be an alkali metal-alkaline earth metal silicate glass. This glass material is available comparatively inexpensively and easily in large quantities. This has the very particular advantage that utility articles of everyday use, such as dishware or hollow vessels for the storage of foodstuffs, especially liquid foodstuffs, for example, can be produced inexpensively with a low inherent weight.

As already mentioned, the disclosure has the particular advantage of a possible saving in material since, for example, for a container of given load-bearing capacity, there is no longer a need for a wall thickness of 3-5 mm, with a wall thickness of 1-3 mm being instead sufficient. Furthermore, there is the further advantage that a glass article produced in accordance with the disclosure, on account of its particular fracture strength (in particular in conjunction with acceptable inherent weight), can be employed in sectors in which presently the use of glass (on account of the risk of fracture) is presently not a viable possibility or is not permitted. One particular possible use of the glass articles produced in accordance with the disclosure lies in particular in the field of packaging. In particular it is possible to replace present plastic packaging inexpensively by glass packaging. In this case as well it is particularly advantageous that the glass material may advantageously be an alkali metal-alkaline earth metal silicate glass that is inexpensive to acquire, more particularly a container glass.

The glass material may advantageously have a silicon dioxide fraction of more than 58% (percent by mass) and of less than 85% (percent by mass), more particularly of more than 70% (percent by mass) and of less than 74% (percent by mass). A glass material which is an alkali metal-alkaline earth metal silicate glass in particular may advantageously have a silicon dioxide fraction of more than 70% (percent by mass) and of less than 74% (percent by mass).

Alternatively or additionally, it is possible advantageously for the glass material to have an alkali metal oxide fraction, more particular sodium oxide fraction (Na₂O) and/or lithium oxide fraction (Li₂O), in the range from 5% (percent by mass) to 20% (percent by mass), more particularly in the range from 10% (percent by mass) to 14.5% (percent by mass) or in the range from 12% (percent by mass) to 13.5% (percent by mass).

The glass material may (alternatively or additionally) advantageously have a potassium oxide fraction (K₂O) of at most 3% (percent by mass), more particularly of at most 3% (percent by mass) or of at most 1% (percent by mass). More particularly the glass material may have a potassium oxide fraction in the range from 0.5% (percent by mass) to 0.9% (percent by mass).

Alternatively or additionally it is possible advantageously for the glass material to have a boron trioxide fraction of less than 15% (percent by mass), more particularly of at most 5% (percent by mass).

As already mentioned, a glass article produced by the method of the disclosure is especially advantageous. This is the case in particular since it has a particular fracture strength and can nevertheless be produced from an inexpensive glass material. The glass article may be embodied, for example, as a hollow body, more particularly a drinking glass, a vase, a tumbler, a bowl or a bottle. It is also possible for the glass article to be embodied as a dishware article, more particularly as a plate or platter. The glass article may also be embodied as flat glass, for a flat screen, for example.

Unless indicated otherwise, percentage figures are percent by mass.

### BRIEF DESCRIPTION OF THE DRAWING VIEWS

In the drawing, the subject matter of the disclosure is represented illustratively and schematically and is described below with reference to the figures, where elements that are the same or have the same effect, even in different exemplary embodiments, are usually provided with the same reference signs. In the figures,

FIG. 1 shows a schematic representation of a first exemplary embodiment of a method sequence of the disclosure,

FIG. 2 shows a schematic representation of a second exemplary embodiment of a method sequence of the disclosure, and

FIGS. 3 to 6 show schematic representations of a third exemplary embodiment of a method sequence of the disclosure.

### DETAILED DESCRIPTION

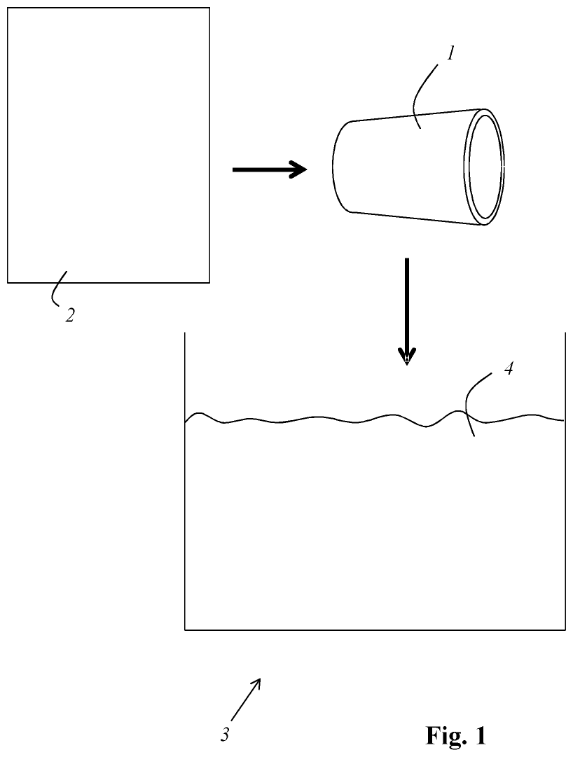

FIG. 1 shows a schematic representation of a first exemplary embodiment of a method sequence of the disclosure, in which in a first step a glass body 1 is produced from a glass material in a production plant 2. This may take place for example by pressing, blowing, sucking or a combination of these techniques. More particularly the production plant 2 may operate according to the blow-and-blow or press-and-blow method. In the exemplary embodiment, the glass body is embodied as a drinking glass.

In a first cooling process, the glass body 1 is cooled outside a cooling bath 3 until a primary temperature has been reached. The primary temperature lies at most 50° Kelvin below and at most 30° Kelvin above the Littleton softening point of the glass material.

As soon as the primary temperature has been reached, the glass body 1 is immersed completely in the cooling bath 3. The cooling bath 3 contains a liquid cooling agent 4, which exhibits a cooling agent temperature which lies at least 200 kelvins and at most 500 kelvins below the primary temperature. The primary temperature and the cooling agent temperature are preferably selected such that the initial cooling rate is around 100 kelvins per second.

After a predetermined time has elapsed since the immersion, this time being preferably longer than 5 minutes, more particularly longer than 10 minutes, the glass body 1 is withdrawn from the cooling bath 3 and cooled further, and cleaned, in a cooling position outside the cooling bath 3.

In particular it may be advantageous for multiple glass bodies 1 to be treated simultaneously in the manner described above. In particular it is possible for a multiplicity of glass bodies 1 to be immersed simultaneously in the cooling bath 3 and removed from the cooling bath 3 for further processing after the cooling procedure, together or in succession.

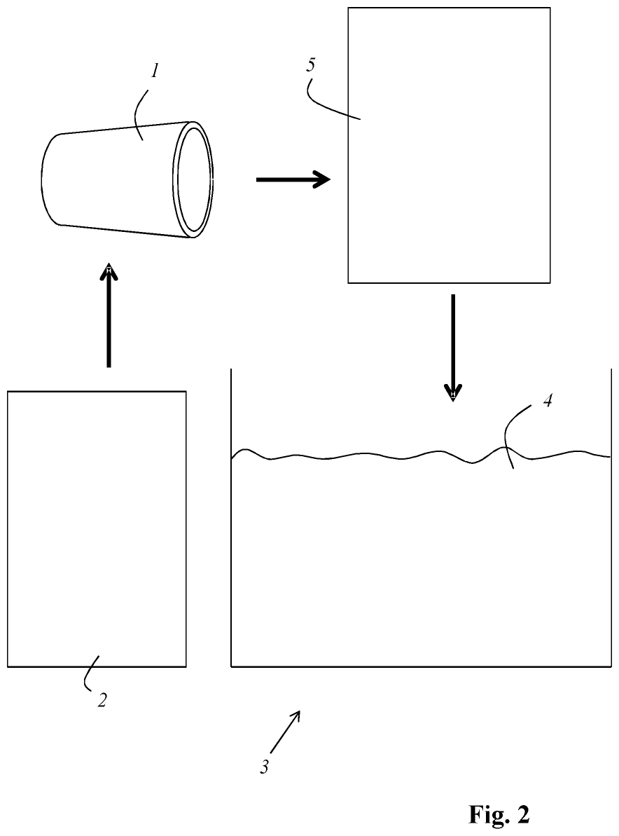

FIG. 2 shows a schematic representation of a second exemplary embodiment of a method sequence of the disclosure, in which in a first step a glass body 1 is produced from a glass material in a production plant 2. This may take place, for example, by pressing, blowing, sucking or a combination of these techniques. More particularly the production plant 2 may operate according to the blow-and-blow or press-and-blow method.

In a further step, the glass body 1 is cooled conventionally first to room temperature. In this state the glass body 1 can advantageously be easily transported and/or assembled with other glass bodies 1 to form a batch for joint further working.

The glass body 1 is subsequently heated until the glass body 1 has reached the primary temperature. For this purpose the glass body 1 is transferred into a kiln 5. The kiln 5 has a kiln temperature which corresponds to the Littleton softening point of the glass material or which lies at most 50 kelvins below and at most 30 kelvins above the Littleton softening point of the glass material. Advantageously the kiln 5 may in particular have a kiln temperature which lies in a range from 10 kelvins to 40 kelvins above the primary temperature.

Glass bodies 1 which are embodied as hollow bodies having walls with a wall thickness remain in the kiln 5 for a heating time in the range from 35 seconds to 45 seconds per millimeter of wall thickness, more particularly for a heating time of 40 seconds per millimeter of wall thickness. Glass bodies which have a flat embodiment and a thickness remain in the kiln 5 for a heating time in the range from 35 seconds to 45 seconds per millimeter of thickness, more particularly for a heating time of 40 seconds per millimeter of thickness.

Following removal from the kiln 5, the glass body 1 is immersed immediately and completely in the cooling bath 3. The cooling bath 3 contains a liquid cooling agent 4 which exhibits a cooling agent temperature which lies at least 200 kelvins and at most 550 kelvins below the primary temperature. The primary temperature and the cooling agent temperature are preferably selected such that initial cooling rate is 100 kelvins per second.

After a predetermined time has elapsed from the immersion, this time being preferably longer than 5 minutes, more particularly longer than 10 minutes, the glass body 1 is withdrawn from the cooling bath 3 and is further cooled, and finally cleaned, in a cooling position outside the cooling bath 3.

It is possible advantageously, in particular, for multiple glass bodies 1 to be treated simultaneously in the manner described above. More particularly a multiplicity of glass bodies 1 may be heated simultaneously in the kiln 5 and then immersed together in the cooling bath 3 and, after the cooling procedure, removed together from the cooling bath 3 for further working.

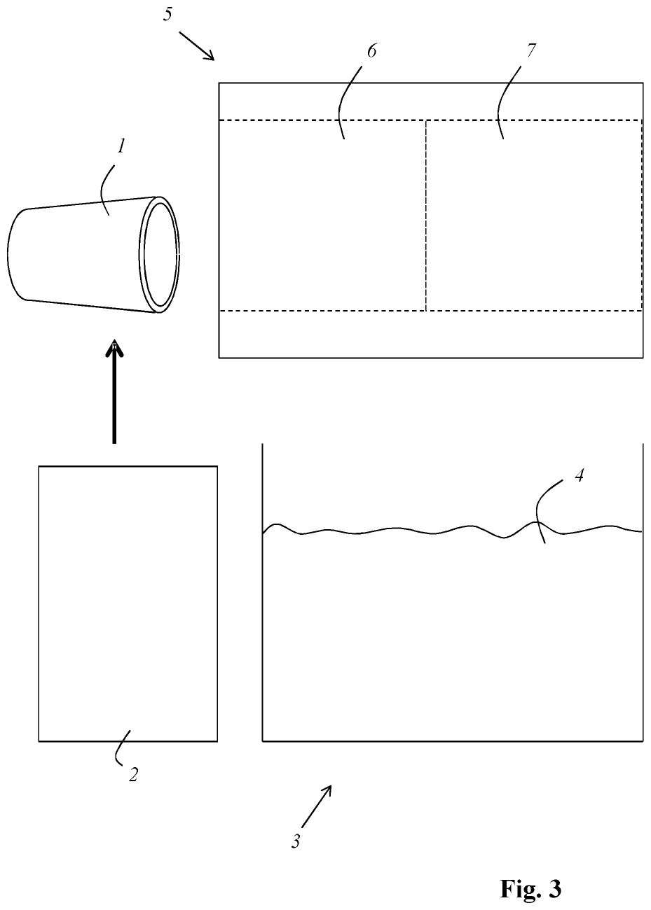

FIGS. 3 to 6 show schematic representation of a third exemplary embodiment of a method sequence of the disclosure, in which in a first step a glass body 1 is produced from a glass material in a production plant 2. This may take place, for example, by pressing, blowing, sucking or a combination of these techniques. More particularly the production plant 2 may operate according to the blow-and-blow or press-and-blow method. In a further step, the glass body 1 is conventionally cooled first to room temperature (FIG. 3). In this condition, the glass body 1 advantageously can be easily transported and/or assembled with other glass bodies 1 to form a batch for joint further working.

The glass body 1 is subsequently heated in a two-stage process until the glass body 1 has reached the primary temperature. For this purpose the glass body 1 is transferred into a kiln 5 which has a first kiln region 6 having a first kiln temperature and a second kiln region having a second kiln temperature which is higher than the first kiln temperature.

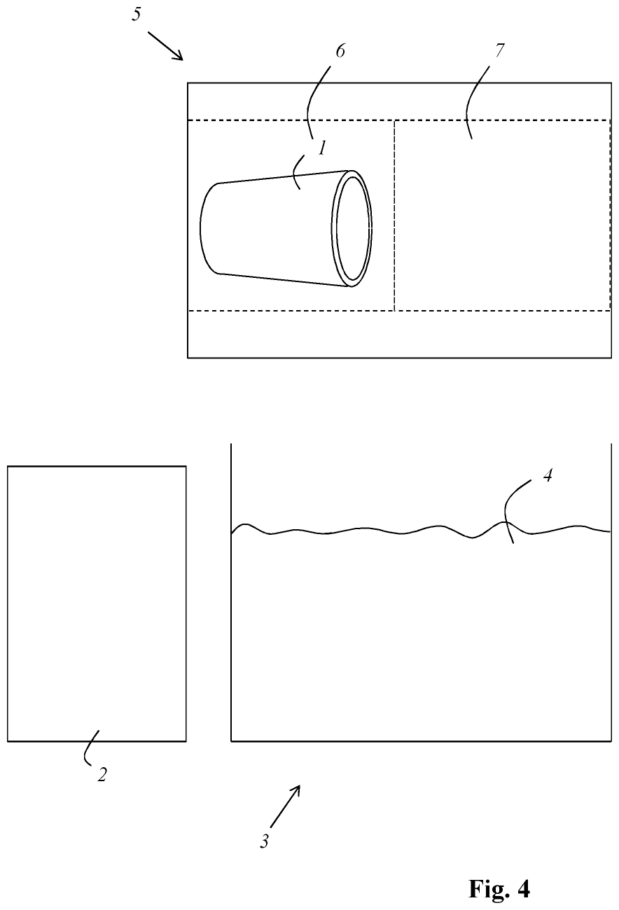

The glass body (1) is first transferred to the first kiln region 6 (FIG. 4), where it is heated to a first temperature. The first temperature lies preferably in a range from 50 kelvins below to 100 kelvins above the transformation temperature of the glass material, more particularly in a range from 0 kelvin to 50 kelvins above the transformation temperature of the glass material.

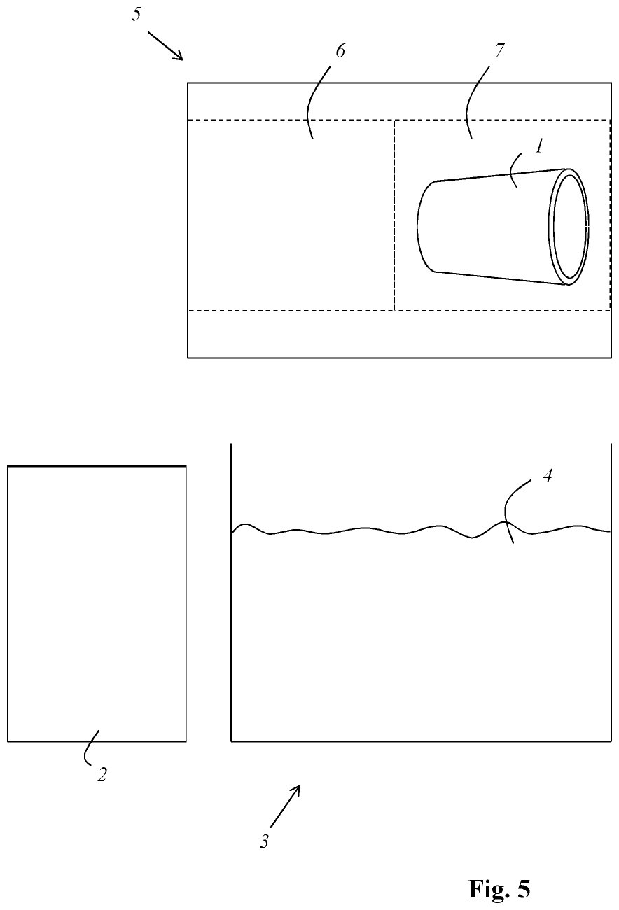

The glass body (1) is thereafter transferred to the second kiln region 7 (FIG. 5), where it is heated to the primary temperature, which lies at most 50 kelvins below and at most 30 kelvins above the Littleton softening point of the glass material.

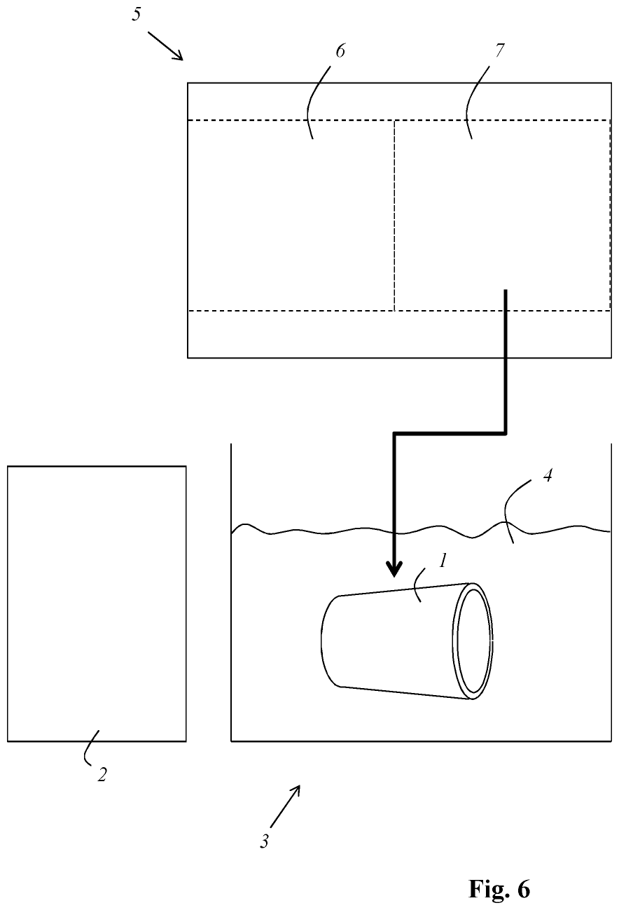

The glass body 1 is then removed from the kiln 5 and immersed, immediately and completely, in the cooling bath 3 (FIG. 6). The cooling bath 3 contains a liquid cooling agent 4 which exhibits a cooling agent temperature which lies at least 200 kelvins and at most 550 kelvins below the primary temperature. The primary temperature and the cooling agent temperature are preferably selected such that initial cooling rate is 100 kelvins per second.

After a predetermined time has elapsed from the immersion, this time being preferably longer than 5 minutes, more particularly longer than 10 minutes, the glass body 1 is withdrawn from the cooling bath 3 and is cooled further, and finally cleaned, in a cooling position outside the cooling bath 3.

It is possible advantageously, in particular, for multiple glass bodies 1 to be treated simultaneously in the manner described above. More particularly a multiplicity of glass bodies 1 may be heated simultaneously in the kiln 5 and then immersed together in the cooling bath 3 and, after the cooling procedure, removed together from the cooling bath 3 for further working.

### LIST OF REFERENCE SIGNS

1 glass body
2 production plant
3 cooling bath
4 liquid cooling agent
5 kiln
6 first kiln region
7 second kiln region

What is claimed is:

1. A method for producing a glass article, characterized by steps as follows:
a. producing a glass body (1) from a glass material, and
b. contacting the glass body (1), at a primary temperature which lies at most 50 kelvins below and at most 30 kelvins above the Littleton softening point of the glass material, with a liquid cooling agent (4) which exhibits a cooling agent temperature which lies at least 200 kelvins and at most 550 kelvins, more particularly at least 200 kelvins and at most 450 kelvins, below the primary temperature.

2. The method as claimed in claim 1, characterized in that the primary temperature and the cooling agent temperature are selected in such a way that
a. the initial cooling rate is in the range from 80 kelvins to 120 kelvins per second, more particularly in the range from 90 kelvins to 110 kelvins per second, or is 100 kelvins per second, or that
b. the initial cooling rate is not less than 80 kelvins per second, more particularly not less than 100 kelvins per second.

3. The method as claimed in claim 1, characterized in that the primary temperature lies at most 30 kelvins below and at most 10 kelvins above the Littleton softening point of the glass material or in that the primary temperature corresponds to the Littleton softening point.

4. The method as claimed in claim 1, characterized in that the glass body (1) is produced from a melt of the glass material and in a first cooling process is cooled outside the cooling bath (3) until the primary temperature is reached and then immediately thereafter is contacted with the liquid cooling agent (4).

5. The method as claimed in claim 1, characterized in that the chilled glass body (1) prior to contacting is heated to the primary temperature.

6. The method as claimed in claim 5, characterized in that for heating, the glass body (1) is transferred into at least one kiln (5).

7. The method as claimed in claim 6, characterized in that the kiln (5) has a kiln temperature which corresponds to the Littleton softening point of the glass material or which lies at most 50 kelvins below and at most 30 kelvins above the Littleton softening point of the glass material.

8. The method as claimed in claim 6, characterized in that the kiln (5) has a kiln temperature which lies in a range from 10 kelvins to 40 kelvins above the primary temperature.

9. The method as claimed in claim 6, characterized in that the glass body (1) is a hollow body with walls which have a wall thickness, and in that the glass body (1) remains in the kiln (5) for a heating time in the range from 35 seconds to 90 seconds, more particularly from 45 seconds to 70 seconds, per millimeter of wall thickness, more particularly for a heating time of 55 seconds per millimeter of wall thickness.

10. The method as claimed in claim 6, characterized in that the glass body (1) has a flat embodiment and has a thickness, and in that the glass body remains in the kiln (5) for a heating time in the range from 35 seconds to 90 seconds, more particularly from 45 seconds to 70 seconds, per millimeter of thickness, more particularly for a heating time of 55 seconds per millimeter of wall thickness.

11. The method as claimed in claim 5, characterized in that the heating takes place in a multistage, more particularly two-stage, process.

12. The method as claimed in claim 11, characterized in that the glass body (1) is first heated to a first temperature at a first heating rate and then is heated to the primary temperature at a second heating rate which is above the first heating rate.

13. The method as claimed in claim 11, characterized in that the glass body (1) is heated first at a first kiln temperature and thereafter at a second kiln temperature which is higher than the first kiln temperature.

14. The method as claimed in claim 13, characterized in that the glass body (1) is exposed to the second kiln temperature for a heating time in the range from 60 seconds to 120 seconds, more particularly from 80 seconds to 100 seconds, or for a heating time of 90 seconds.

15. The method as claimed in claim 1, characterized in that the contacting takes place by immersion of the glass article in a cooling bath which contains the cooling agent.

16. The method as claimed in claim 1, characterized in that the contacting takes place by spraying or by sprinkling with the cooling agent.

17. The method as claimed in claim 1, characterized in that the cooling agent (4) contains an oil and/or a metal and/or a salt melt or in that the cooling agent is an oil or a metal or a salt melt.

18. The method as claimed in claim 1, characterized in that the glass material is an alkali-containing silicate glass, more particularly an alkali metal-alkaline earth metal silicate glass, especially a soda-lime glass, or a borosilicate glass or an aluminosilicate glass.

19. The method as claimed in claim 1, characterized in that the glass material has a silicon dioxide fraction of more than 58% (percent by mass) and of less than 85% (percent by mass), more particularly of more than 70% (percent by mass) and of less than 74% (percent by mass).

20. The method as claimed in claim 1, characterized in that the glass material has an alkali metal oxide fraction, more particular sodium oxide fraction and/or lithium oxide fraction, in the range from 5% (percent by mass) to 20% (percent by mass), more particularly in the range from 10% (percent by mass) to 14.5% (percent by mass) or in the range from 12% (percent by mass) to 13.5% (percent by mass).

21. The method as claimed in claim 1, characterized in that the glass material has a potassium oxide fraction of at most 7% (percent by mass), more particularly of at most 3% (percent by mass) or of at most 1% (percent by mass), or in that the glass material has a potassium oxide fraction in the range from 0.5% (percent by mass) to 0.9% (percent by mass).

22. The method as claimed in claim 1, characterized in that the glass material has a boron trioxide fraction of less than 15% (percent by mass), more particularly of at most 5% (percent by mass).

23. The method as claimed in claim 1, characterized in that the liquid coolant is contacted progressively or at time intervals, more particularly constant time intervals, with a regeneration material, more particularly a solid regeneration material.

24. A glass article produced by means of a method as claimed in claim 1.

25. The glass article as claimed in claim 24, characterized in that the glass article is embodied as a hollow body, more particularly a drinking glass, a vase, a tumbler, a bowl or a bottle.

26. The glass article as claimed in claim 25, characterized in that the glass article is embodied as a dishware article, more particularly as a plate.

27. The glass article as claimed in claim 25, characterized in that the glass article is embodied as flat glass.
